(19) United States
(12) Patent Application Publication
(10) Pub. No.: US 2009/0287893 A1
(43) Pub. Date: Nov. 19, 2009

(54) METHOD FOR MANAGING MEMORY

(75) Inventors: CHUANG CHENG, HSINCHU (TW); SHIH CHIEH TAI, HSINCHU (TW); MING HUI LIN, HSINCHU (TW); CHIH NAN YEN, HSINCHU (TW); FUJA SHONE, HSINCHU (TW)

Correspondence Address: WPAT, PC;INTELLECTUAL PROPERTY ATTORNEYS, 2030 MAIN STREET, SUITE 1300, IRVINE, CA, 92614, US

(73) Assignee: SKYMEDI CORPORATION, HSINCHU (TW)

(21) Appl. No.: 12/122,568

(22) Filed: May 16, 2008

(51) Int. Cl. G06F 12/12

(52) U.S. Cl. 711/159; 711/E12.069

(57) ABSTRACT

A method is employed to manage a memory, e.g., a flash memory, including a plurality of paired pages. Each paired page includes a page and a respective risk zone. For each write command, at least one unwritten page is selected for writing new data. For each unwritten page whose risk zone includes at least one written page, each written page is copied or backed up, and the new data is written to the unwritten page. For each unwritten page whose risk zone lacks a written page, the new data is written to the unwritten page. In an embodiment, the written page is copied only if the unwritten page and the written page are operated by different write commands.

### BACKGROUND OF THE INVENTION

(A) Field of the Invention

The present invention relates to a method for managing a memory and, more particularly, to a method of managing a multi-level cell (MLC) memory to avoid data corruption when power is unexpectedly interrupted.

(B) Description of Related Art

Multi-level cell flash memories are widely used for data storage nowadays. Flash memory is a form of EEPROM (electronically erasable programmable read-only memory) non-volatile memory. The operations that a controller performs on NAND flash media include read, write and erase operations. NAND Flash media typically are written in units called “pages,” each of which typically includes between 512 bytes and 2048 bytes, and typically are erased in units called “blocks,” each of which typically includes between 64 and 128 pages.

For non-volatile memory data storage, a major risk to the integrity of data storage is a sudden power failure in the middle of an operation. Such a power failure often causes the interrupted operation to have erratic or unpredictable results.

If the power failure occurs in an operation changing the contents of NAND flash media, for example in the middle of writing a page of data or in the middle of erasing a block, the contents of the interrupted page or block are unpredictable after being powered up again. This is because some of the affected bits may have gotten to the state assigned to them by the operation by the time power was interrupted, while other bits were lagging behind and not yet at their target values. For an MLC memory, one cell can store two pages, and these two pages form “a paired page.” Therefore, when programming one page of the paired page, the other page of the paired page would be influenced because the cell voltage level is changed. Consequently, if one page of a paired page has been written and power failure occurs while the other page is being written, the written page will be lost. Therefore, there is a demand to find an effective solution to resolve the page loss problems.

### SUMMARY OF THE INVENTION

The present invention provides a management method for a memory of paired page structure to avoid data loss or damage due to power interruption.

In accordance with the present invention, a method is employed to manage a memory, e.g., a flash memory, including a plurality of paired pages. Each paired page includes a page and a respective risk zone. For each write command, at least one unwritten page is selected for writing new data. For each unwritten page whose risk zone includes at least one written page, each written page is copied, and the new data is written to the unwritten page. For each unwritten page whose risk zone lacks written pages, the new data is written to the unwritten page.

According to an embodiment of the present invention, the writing for the unwritten page whose risk zone includes at least one written page may be performed in accordance with sequential page address order, and the writing for the unwritten page whose risk zone has no written page may be performed in accordance with random page address order.

In an embodiment, the written page is copied only if the unwritten page and the written page are not operated by the same write command.

According to the present invention, the written page may be copied, or the unwritten page is written only if its risk zone has no written page. As a result, even if power failure occurs, the written page will not be corrupted.

### BRIEF DESCRIPTION OF THE DRAWINGS

FIG. 1 illustrates a paired page structure of a flash memory;

FIG. 2 illustrates paired pages of a flash memory in accordance with an embodiment of the present invention;

FIG. 3 illustrates a method for managing a memory in accordance with an embodiment by sequential write of the present invention; and

FIG. 4 illustrates a method for managing a memory in accordance with an embodiment by random write of the present invention;

### DETAILED DESCRIPTION OF THE INVENTION

Embodiments of the present invention will now be described with reference to the accompanying drawings.

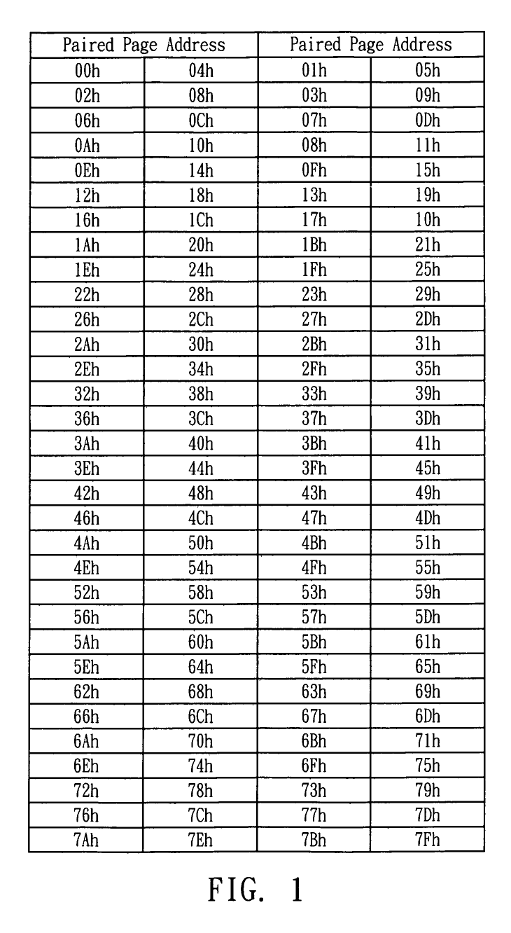

FIG. 1 illustrates a paired page structure of Samsung MLC flash memory (K9G8G08U0A). Every two pages constitutes a paired page. For instance, Page Addresses 00h and 04h constitute a paired page, Page Addresses 02h and 08h constitute another paired page, etc.

Normally, the flash memory is controlled by a controller in sequential write or random write manner. For sequential write, data is written to pages according to incremental page address order. For random write, data is written to pages according to random address order. To facilitate the management of NAND flash media, the host assigns each page a status of “unwritten” or “written.” A page whose status is “unwritten” is a page that has not been written since the last time it was erased, and so is available for writing. A page whose status is “written” is a page to which data has been written and not yet erased.

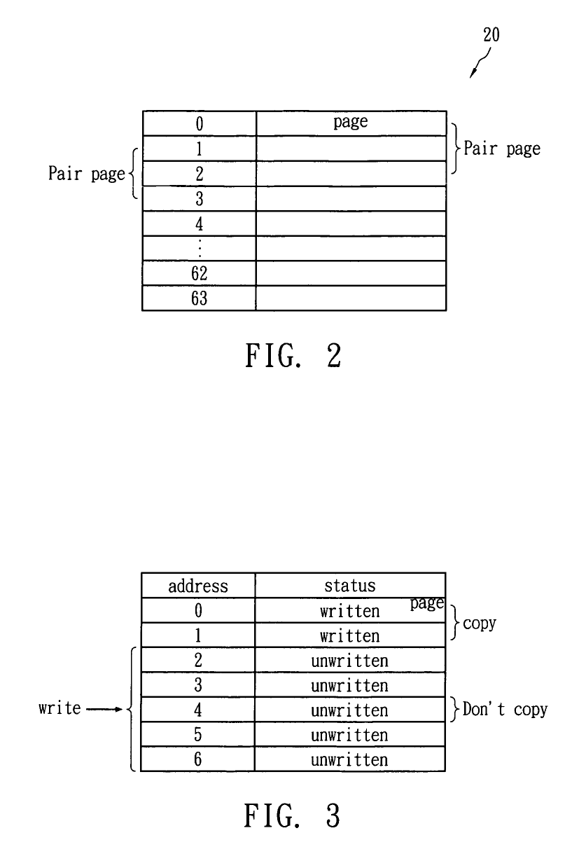

FIG. 2 exemplifies a paired page structure of a memory block. A block 20 includes 64 pages in which, for example, Page 0 and Page 2 constitute a paired page, and Page 1 and Page 3 constitute another paired page. Given that Page 0 is written, the written Page 0 will be corrupted if power failure occurs in the middle of writing to Page 2 because of voltage change to the cell of the paired page. Page 0 is called a “risk zone” for the paired page including Page 0 and Page 2, i.e., the data contained therein would be corrupted if power failure occurs while the corresponding page of the paired page is being written.

Referring to FIG. 3, Page 0 and Page 2 constitute a paired page, Page 1 and Page 3 constitute a paired page, and Page 4 and Page 6 constitute a paired page. The page operations are performed by sequential lo write. Page 0 and Page 1 have been written in a write command, and Pages 2 to 6 are “unwritten.” Accordingly, Page 0 and Page 1 are “risk zones” for Page 2 and Page 3, respectively. A new write command comprises Pages 2 to 6. In order to prevent page corruption caused by failure interruption, the risk zones Page 0 and Page 1 are copied. Although Page 6 is a risk zone for Page 4, written Page 4 is not copied in consideration that Page 6 and Page 4 belong to the same write command. In other words, it is not necessary to copy the risk zone for the same write command, and only the risk zone for the previous write command is copied.

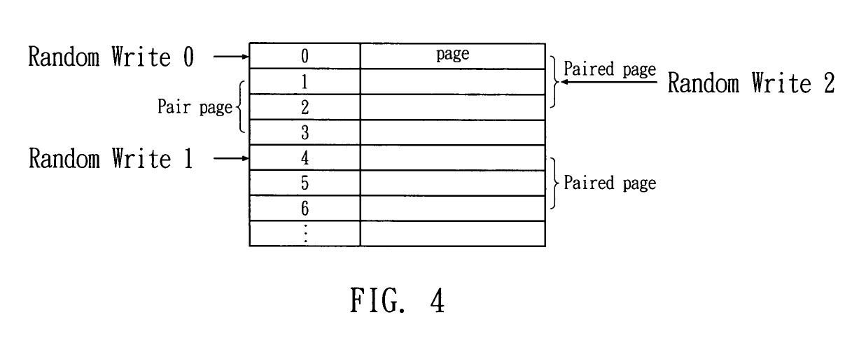

As shown in FIG. 4, Page 0 and Page 2 constitute a paired page, Page 1 and Page 3 constitute a paired page, and Page 4 and Page 6 constitute a paired page. The page operations are performed by random write. In this embodiment, for Random Write 0, only Page 0 is written and Page 2 is unwritten. (Alternatively, Page 2 is written and Page 0 is unwritten.) For Random Write 1, only Page 4 is written and Page 6 is unwritten. For Random Write 2, only Page 1 is written and Page 3 is unwritten. In other words, only one page of a paired page is written, the other page is unwritten, i.e., the risk zone of a paired page lacks or has no written page. For example, the page to be written may be the high page address page (MSB) or the low page address page (LSB). Because the risk zone of a paired page lacks or has no written page, it is unlikely to corrupt any written page even if power interruption occurs.

The above-described embodiments of the present invention are intended to be illustrative only. Numerous alternative embodiments may be devised by those skilled in the art without departing from the scope of the following claims.

What is claimed is:

1. A method for managing a memory that comprises a plurality of paired pages each including a page and a respective risk zone, the method comprising the steps of:
(a) for each write command, selecting at least one unwritten page for writing new data;
(b) for each said unwritten page whose risk zone includes at least one written page, and each said written page being not operated by said write command, copying each said written page; and
(c) writing said new data to said unwritten page.

2. The method for managing a memory of claim 1, wherein said memory is a multi-level cell flash memory.

3. The method for managing a memory of claim 1, wherein said writing is performed in accordance with sequential page address order.

4. The method for managing a memory of claim 1, further comprising the steps of:
for each said unwritten page whose risk zone lacks a written page, writing said new data to said unwritten page.

5. The method for managing a memory of claim 4, wherein said writing for each said unwritten page whose risk zone lacks a written page is performed in accordance with random page address order.

6. The method for managing a memory of claim 4, wherein said unwritten page whose risk zone lacks a written page is a high page address page or a low page address page of a paired page.

7. A method for managing a memory that comprises a plurality of paired pages each including a page and a respective risk zone, the method comprising the steps of:
(a) selecting at least one unwritten page for writing new data;
(b) for each said unwritten page whose risk zone lacks a written page, writing said new data to said at least one unwritten page; and
(c) for each said unwritten page whose risk zone includes at least one written page, copying each said written page, and writing said new data to said unwritten page.

8. The method for managing a memory of claim 7, wherein said writing in step (b) is performed in accordance with random page address order.

9. The method for managing a memory of claim 7, wherein said writing in step (c) is performed in accordance with incremental page address sequential order.

10. The method for managing a memory of claim 7, wherein in step (c) each said unwritten page and each said written page are operated by different write commands.

11. The method for managing a memory of claim 7, wherein said memory is a multi-level cell flash memory.
